(19) United States
(12) Patent Application Publication
(10) Pub. No.: US 2025/0299872 A1
(43) Pub. Date: Sep. 25, 2025

(54) INTEGRATED MAGNETIC COMPONENT

(71) Applicant: SEA SONIC ELECTRONICS CO., LTD., Taipei (TW)

(72) Inventors: Chien-Tung LAN, Taipei (TW); Chih-Sheng CHANG, Taipei (TW); Chi-Hao CHANG, Taipei (TW); Sheng-Chien CHOU, Taipei (TW)

(21) Appl. No.: 18/613,357

(22) Filed: Mar. 22, 2024

(51) Int. Cl. H01F 27/32; H01F 27/24

(52) U.S. Cl. CPC H01F 27/32; H01F 27/24

(57) ABSTRACT

An integrated magnetic component comprises a transformer, a resonant inductor, a current comparator, and a second insulator. The transformer includes a transformer magnetic core and a transformer winding disposed on the transformer magnetic core. The resonant inductor includes an inductor magnetic core contacting the transformer magnetic core, and an inductor winding disposed on the inductor magnetic core. The resonant inductor shares a magnetic circuit with the transformer. The current comparator includes a current comparator magnetic core, a current comparator winding disposed on the current comparator magnetic core, and a first insulator disposed around the current comparator magnetic core. The current comparator, the resonant inductor and the transformer are arranged to form an integrated structure. The second insulator is disposed around the integrated structure.

### FIELD OF THE INVENTION

The invention relates to a magnetic component, and more particularly to a magnetic component integrated with a transformer, a resonant inductor and a current comparator.

### BACKGROUND OF THE INVENTION

Although Patents CN 219659573U and CN 219163167U have disclosed the design of integrating a transformer and a resonant inductor to form an integrated structure, there is currently no technical solution that integrates a current comparator.

### SUMMARY OF THE INVENTION

A main object of the invention is to solve the problems caused by the conventional current comparator, transformer and resonant inductor being independent structures.

In order to achieve the above object, the invention provides an integrated magnetic component, the integrated magnetic component includes a transformer, a resonant inductor, a current comparator, and a second insulator. The transformer includes a transformer magnetic core and a transformer winding disposed on the transformer magnetic core. The resonant inductor includes an inductor magnetic core contacting the transformer magnetic core, and an inductor winding disposed on the inductor magnetic core. The resonant inductor shares a magnetic circuit with the transformer. The current comparator includes a current comparator magnetic core, a current comparator winding disposed on the current comparator magnetic core, and a first insulator disposed around the current comparator magnetic core. The current comparator, the resonant inductor and the transformer are arranged to form an integrated structure. The second insulator is disposed around the integrated structure.

In one embodiment, the transformer winding comprises a first primary winding and a first secondary winding, the current comparator winding comprises a second primary winding and a second secondary winding, the first primary winding, the inductor winding and the second primary winding are wound by a wire material.

In one embodiment, two ends of the wire material are located on a side same as the integrated magnetic component.

In one embodiment, the first secondary winding comprises a plurality of conductive plates and a plurality of insulating plates, and each of the plurality of insulating plates is respectively disposed between any two adjacent of the plurality of conductive plates.

In one embodiment, the current comparator magnetic core is EI type.

In one embodiment, the inductor magnetic core is E type, the inductor magnetic core includes a plurality of legs and a body connected to the plurality of legs, and the plurality of legs contact the transformer magnetic core.

In one embodiment, the current comparator is adjacent to the resonant inductor, and the first insulator is sandwiched between the current comparator magnetic core and the inductor magnetic core.

Through the foregoing implementation of the invention, compared with the prior art, the invention has the following characteristics: the integrated magnetic component of the invention integrates the transformer, the resonant inductor and the current comparator into a single unit, which is capable of increasing a power density of a circuit used in the application, and the wiring is also relatively simple.

### BRIEF DESCRIPTION OF THE DRAWINGS

FIG. 1 is a perspective structural view of an embodiment of an integrated magnetic component of the invention.

FIG. 2 is a structural top view of an embodiment of the integrated magnetic component of the invention.

FIG. 3 is an exploded perspective view of structures of an embodiment of the integrated magnetic component of the invention.

FIG. 4 is an exploded perspective view of partial structures of an embodiment of the integrated magnetic component of the invention.

FIG. 5 is an exploded perspective view of a current comparator of an embodiment of the integrated magnetic component of the invention.

### DETAILED DESCRIPTION OF THE PREFERRED EMBODIMENTS

The terms “first” and “second” used in the following description are only used to distinguish different components and do not represent the order of the components.

The detailed description and technical content of the invention are described below with reference to the drawings.

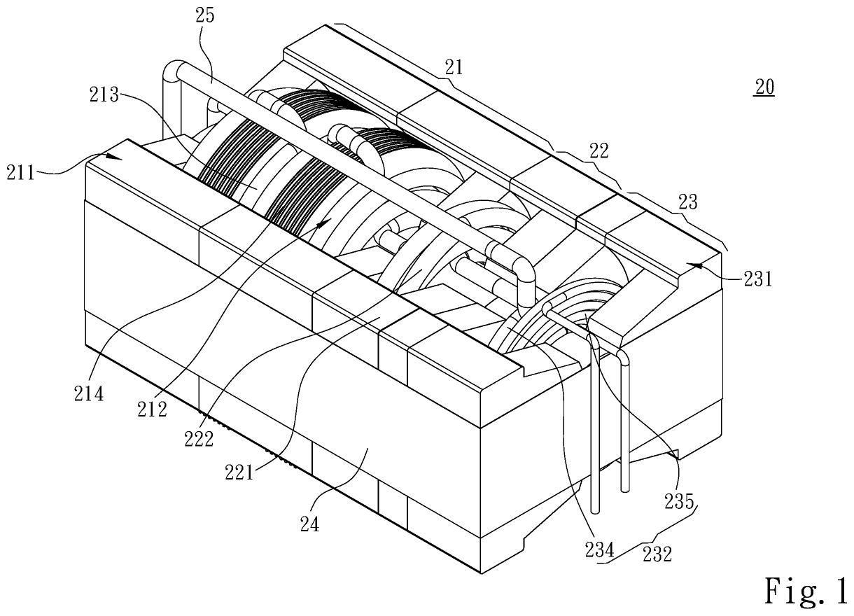

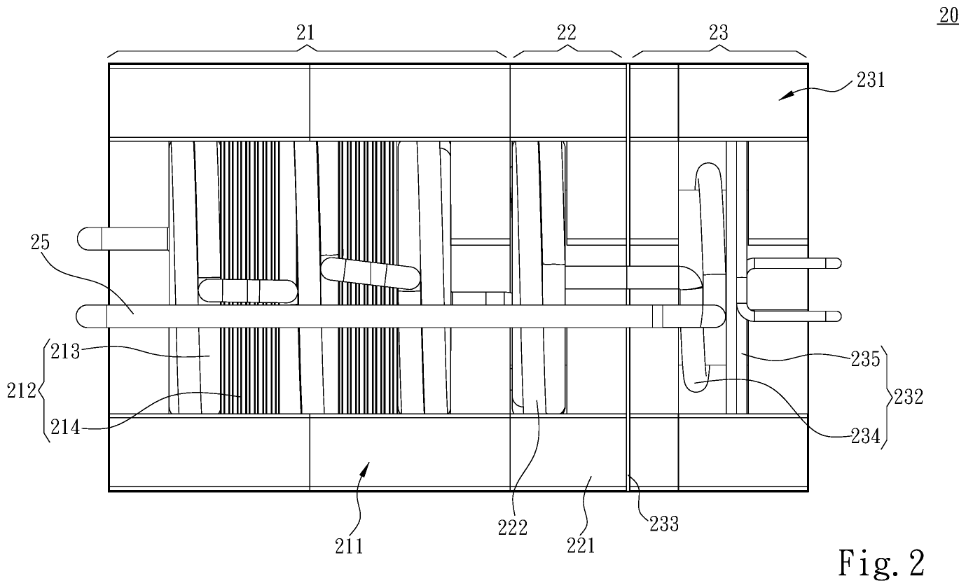

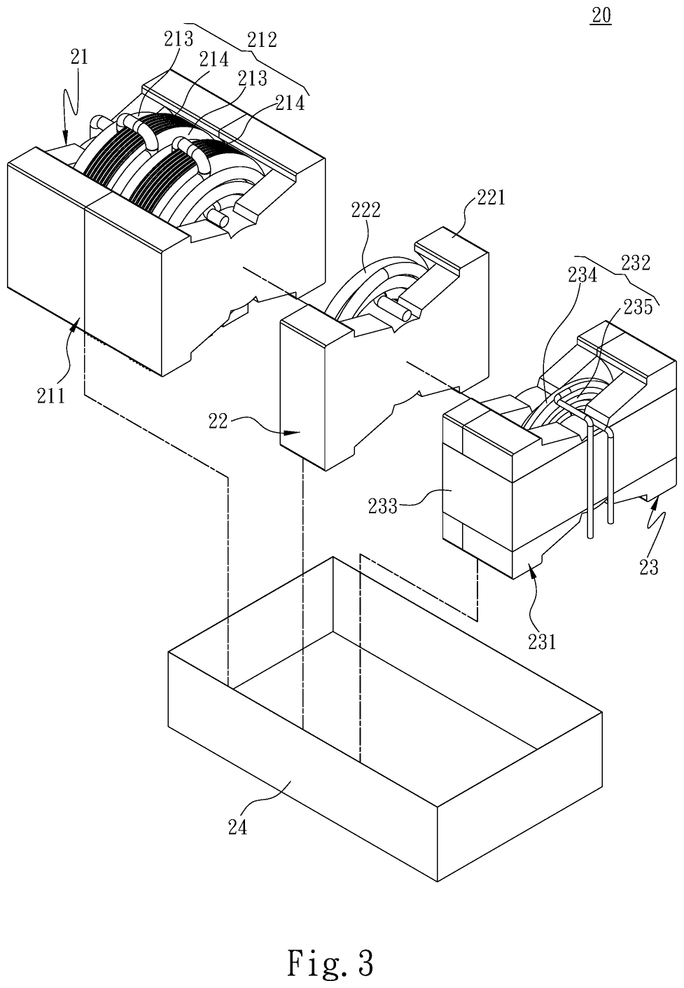

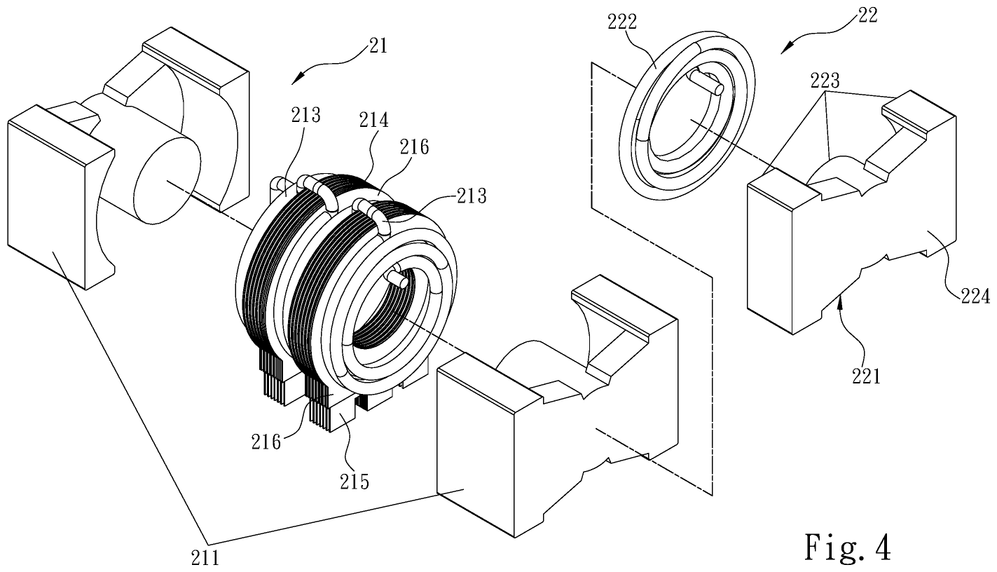

Please refer to FIG. 1, FIG. 2, FIG. 3 and FIG. 4. The invention provides an integrated magnetic component 20 applied to resonant conversion circuits or phase shift conversion circuits. Specifically, the integrated magnetic component 20 is applied to power supply applications in ATX (Advanced Technology Extended) and its extended specifications.

The integrated magnetic component 20 comprises a transformer 21, a resonant inductor 22 and a current comparator 23. The transformer 21 comprises a transformer magnetic core 211 and a transformer winding 212. In one embodiment, the transformer magnetic core 211 is composed of a plurality of parts. In this embodiment, the transformer magnetic core 211 is EE type, but the invention is not limited thereto. The transformer winding 212 is provided on the transformer magnetic core 211, and the transformer winding 212 comprises a first primary winding 213 and a first secondary winding 214.

Please refer to FIG. 3 and FIG. 4. The resonant inductor 22 includes an inductor magnetic core 221 and an inductor winding 222. The inductor magnetic core 221 contacts the transformer magnetic core 211. Specifically, the inductor magnetic core 221 is E-type, and the inductor magnetic core 221 includes a plurality of legs 223 and a body 224. The plurality of legs 223 are connected to the body 224, and the plurality of legs 223 face the same side. The inductor magnetic core 221 contacts the transformer magnetic core 211 with two of the plurality of legs 223 so that the resonant inductor 22 and the transformer 21 share a magnetic circuit. The plurality of legs 223 served as center pillars may not contact the transformer magnetic core 211 to form a leakage inductance. In addition, the inductor winding 222 is provided on the inductor magnetic core 221.

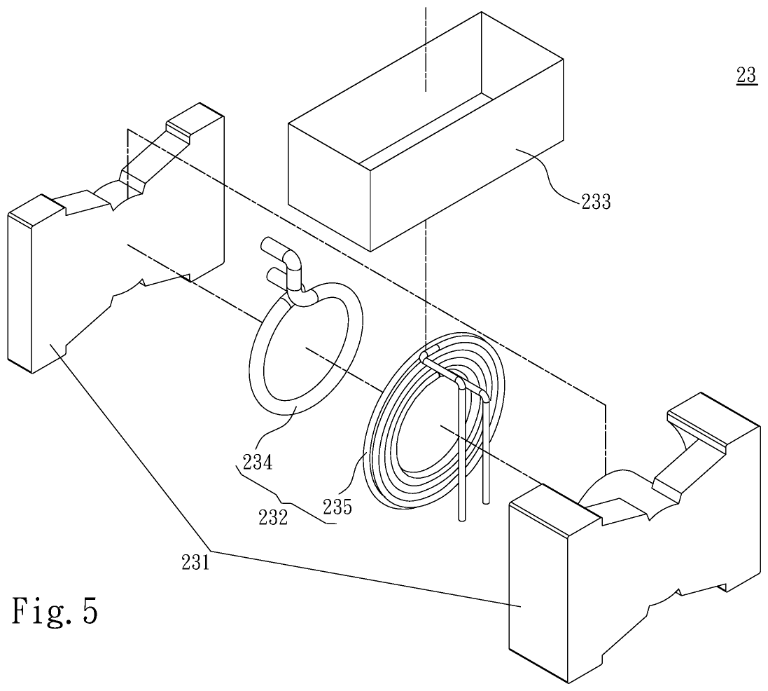

Please refer to FIG. 5. The current comparator 23 includes a current comparator magnetic core 231, a current comparator winding 232, and a first insulator 233. In one embodiment, the current comparator magnetic core 231 is composed of a plurality of parts. In one embodiment, the current comparator magnetic core 231 is EI type. In addition, the current comparator winding 232 is provided on the current comparator magnetic core 231, and the current comparator winding 232 comprises a second primary winding 234 and a second secondary winding 235. The first insulator 233 is wound around the current comparator magnetic core 231. The first insulator 233 is disposed on the current comparator magnetic core 231. The first insulator 233 is formed by a short-circuiting connection between two ends of a Mylar copper foil tape or others capable of producing a same efficacy.

The current comparator 23, the resonant inductor 22 and the transformer 21 are arranged to form an integrated structure. It should be understood that the current comparator 23 does not share a magnetic circuit with the resonant inductor 22 and the transformer 21, through the first insulator 233. In one embodiment, the current comparator 23 is adjacent to the resonant inductor 22, and the first in insulator 233 is sandwiched between the current comparator magnetic core 231 and the inductor magnetic core 221.

Please refer to FIG. 1, FIG. 2 and FIG. 3. The integrated magnetic component 20 of the invention further comprises a second insulator 24 disposed around the integrated structure. The second insulator 24 can be a Mylar tape or others capable of producing a same efficacy. In addition, the transformer 21 and the resonant inductor 22 of the invention sharing a magnetic circuit is capable of increasing a power density, and an inductance is easy to adjust and control. On the other hand, implementation of the integrated structure is capable of significantly reducing problems with a power density and wiring caused by dispersed structures, and making a circuit wiring simpler.

Please refer to FIG. 1 and FIG. 2. In one embodiment, the first primary winding 213, the inductor winding 222 and the second primary winding 234 are wound by a wire material 25. Further, two ends of the wire material 25 are located on a side same as the integrated magnetic component 20.

Please refer to FIG. 4. In one embodiment, the first secondary winding 214 comprises a plurality of conductive plates 215 and a plurality of insulating plates 216. Each of the plurality of insulating plates 216 is respectively disposed between any two adjacent of the plurality of conductive plates 215, that is to say, one of the plurality of insulating plates 216 is sandwiched between the plurality of conductive plates 215. The plurality of conductive plates 215 is connected through a printed circuit (not shown in the figures).

What is claimed is:

1. An integrated magnetic component, comprising:
a transformer, comprising a transformer magnetic core and a transformer winding disposed on the transformer magnetic core;
a resonant inductor, comprising an inductor magnetic core contacting the transformer magnetic core, and an inductor winding disposed on the inductor magnetic core, the resonant inductor sharing a magnetic circuit with the transformer;
a current comparator, comprising a current comparator magnetic core, a current comparator winding disposed on the current comparator magnetic core, and a first insulator disposed around the current comparator magnetic core, the current comparator, the resonant inductor and the transformer being arranged to form an integrated structure; and
a second insulator, disposed around the integrated structure.

2. The integrated magnetic component as claimed in claim 1, wherein the transformer winding comprises a first primary winding and a first secondary winding, the current comparator winding comprises a second primary winding and a second secondary winding, the first primary winding, the inductor winding and the second primary winding are wound by a wire material.

3. The integrated magnetic component as claimed in claim 2, wherein two ends of the wire material are located on a side same as the integrated magnetic component.

4. The integrated magnetic component as claimed in claim 2, wherein the first secondary winding comprises a plurality of conductive plates and a plurality of insulating plates, and each of the plurality of insulating plates is respectively disposed between any two adjacent of the plurality of conductive plates.

5. The integrated magnetic component as claimed in claim 4, wherein the current comparator magnetic core is EI type.

6. The integrated magnetic component as claimed in claim 5, wherein the inductor magnetic core is E type, the inductor magnetic core comprises a plurality of legs and a body connected to the plurality of legs, and two of the plurality of legs contact the transformer magnetic core.

7. The integrated magnetic component as claimed in claim 6, wherein the current comparator is adjacent to the resonant inductor, and the first insulator is sandwiched between the current comparator magnetic core and the inductor magnetic core.

8. The integrated magnetic component as claimed in claim 1, wherein the transformer winding comprises a first primary winding and a first secondary winding, the first secondary winding comprises a plurality of conductive plates and a plurality of insulating plates, and each of the plurality of insulating plates is respectively disposed between any two adjacent of the plurality of conductive plates.

9. The integrated magnetic component as claimed in claim 1, wherein the inductor magnetic core is E type, the inductor magnetic core comprises a plurality of legs and a body connected to the plurality of legs, and the plurality of legs contact the transformer magnetic core.

10. The integrated magnetic component as claimed in claim 1, wherein the current comparator is adjacent to the resonant inductor, and the first insulator is sandwiched between the current comparator magnetic core and the inductor magnetic core.
